(19) United States
(12) Patent Application Publication
(10) Pub. No.: US 2012/0331514 A1
(43) Pub. Date: Dec. 27, 2012

(54) METHOD AND APPARATUS FOR PROVIDING IMAGE-ASSOCIATED INFORMATION

(75) Inventors: Seung-ho YEON, Yongin-si (KR); Tae-seok SUH, Seoul (KR); Hyung-jin YOON, Anyang-si (KR); Myung-soon LEE, Seoul (KR)

(73) Assignee: KT CORPORATION, Seongnam (KR)

(21) Appl. No.: 13/534,856

(22) Filed: Jun. 27, 2012

(30) Foreign Application Priority Data
Jun. 27, 2011 (KR) 10-2011-0062319

(51) Int. Cl. H04N 21/25; H04N 21/262

(52) U.S. Cl. 725/97; 725/93

(57) ABSTRACT

A method of providing image-associated information by an image-associated information providing apparatus includes receiving broadcasting image information from a mobile device, searching an object that matches the broadcasting image information, extracting image-associated information that matches the found object and transmitting the extracted image-associated information to the mobile device.

### CROSS-REFERENCE TO RELATED PATENT APPLICATION

This application claims the benefit of priority from the Korean Patent Application No. 10-2011-0062319, filed on Jun. 27, 2011 in the Korean Intellectual Property Office, the entire disclosure of which is incorporated herein by reference in its entirety.

### BACKGROUND

1. Field

Exemplary embodiments broadly relate to a method and an apparatus for providing image-associated information, and more particularly, exemplary embodiments relate to a method and an apparatus for providing image-associated information output using a mobile device.

2. Description of the Related Art

With a recent development of a mobile device capable of taking pictures and performing network communications, a VR (Virtual Reality) technology using a camera of the mobile device has been developed, and various services have been provided using the VR technology.

Further, as various contents are provided to users through IPTV or the like, there has been a demand for providing the users with information about a person or an object such as an actor/actress, a watch or a bag provided to the users in the contents such as broadcasting programs. To meet such a requirement, there has been developed a technology for providing the users with the required information as well as the broadcasting programs in response to the users' request.

Clear skin technology is an example of one of such related art technologies. According to this technology, an extra skin is inserted into a VOD (Video on Demand) contents, and if a user requests information matched with an object in the contents through a remote controller, the requested information is received from a server and provided to the user using a screen. In order to provide the users with information about the broadcasting programs by using such a clear skin technology, skins need to be prepared and inserted into the broadcasting programs beforehand.

### SUMMARY

Accordingly, it is an aspect to provide a method and an apparatus for providing image-associated information, capable of generating an image of a broadcasting program by using an image capturing device such as a camera in a mobile device and which is capable of performing network communications, and capable of proving a user with such image-associated information as information about a person or a product contained in the acquired image.

According to an aspect of exemplary embodiments, there is provided a method of providing image-associated information. The method includes receiving broadcasting image information from a mobile device, searching for an object that matches the received broadcasting image information, extracting image-associated information that matches the object found in the searching and transmitting the extracted image-associated information to the mobile device.

According to another aspect of exemplary embodiments, there is provided a method of obtaining image-associated information. The method includes generating a broadcasting image, transmitting, by a mobile device, broadcasting image information comprising the generated broadcasting image to a remote apparatus, receiving, by the mobile device, image-associated information corresponding to the transmitted broadcasting image information from the remote apparatus.

According to yet another aspect of exemplary embodiments, an image-associated information providing apparatus includes a pattern searching unit configured to search for a pattern in broadcasting image information received from a mobile device, an object searching unit configured to search for an object that matches the pattern found by the pattern searching unit, and an image-associated information extracting unit configured to extract image-associated information that matches the searched object and a communication unit configured to provide the image-associated information to the mobile device.

In exemplary embodiments, since the broadcasting image of the broadcasting program generated by the image capturing device of the mobile device is analyzed and image-associated information is provided to the user, it is possible to provide the user with the image-associated information without needing to prepare an additional skin for the broadcasting program.

Further, in exemplary embodiments, since sub-information about the broadcasting program input by a user is also sent to an apparatus such as the image-associated information providing server together with the broadcasting image, the object such as a person or a product contained in the broadcasting image generated by the mobile device of the user may be analyzed more accurately and more easily. Thus, the information associated with the image can be provided to the user effectively.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not intended to limit its scope, the exemplary embodiments will be described with specificity and detail taken in conjunction with the accompanying drawings, in which:

FIG. 1 is a view illustrating a configuration of a system for providing image-associated information according to an exemplary embodiment;

FIG. 2 is a flow diagram illustrating a method of providing image-associated information according to an exemplary embodiment;

FIG. 3 is a block diagram illustrating a mobile device according to an exemplary; and

FIG. 4 is a block diagram illustrating an image-associated information providing server according to an exemplary embodiment.

### DETAILED DESCRIPTION OF EXEMPLARY EMBODIMENTS

Hereinafter, exemplary embodiments will be described in detail with reference to the accompanying drawings to be readily implemented by those skilled in the art. However, it is to be noted that the present disclosure is not limited to the exemplary embodiments, but can be realized in various other ways. In the drawings, certain parts not directly relevant to the description of exemplary embodiments are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

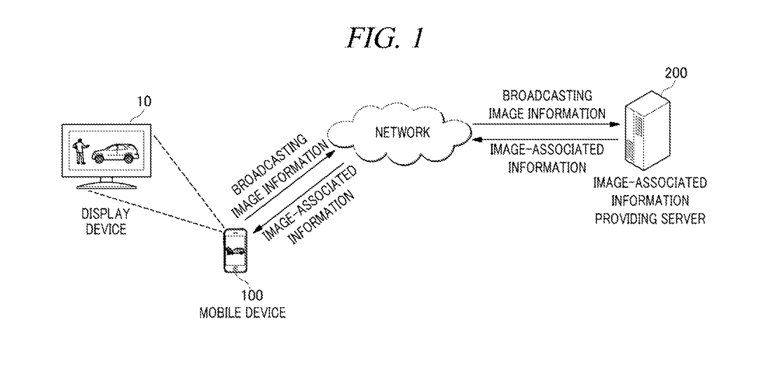

FIG. 1 is a view illustrating a configuration of a system for providing image-associated information according to an exemplary embodiment.

According to an exemplary embodiment, a user acquires an image of a broadcasting program output on a screen of a display device 10, e.g., a TV by using a mobile device 100 such as a smart phone, a PDA (Personal Digital Assistant) or a tablet PC.

That is, by using an image capturing device such as a camera included in the mobile device 100, the user may generate a broadcasting image by capturing an image of the screen of the display device 10 that is outputting the broadcasting program.

The mobile device 100 transmits the generated broadcasting image to an image-associated information providing server 200 through a network. At this time, the mobile device 100 may transmit sub-information to the image-associated information providing server 200 as well as the broadcasting image.

By way of example, the mobile device 100 may provide a user with broadcasting schedule information or VOD list information. By using program information including the provided broadcasting schedule information or VOD list information, the user may select a broadcasting program that the user is currently watching. The mobile device 100 may transmit the sub-information generated by selecting the broadcasting program from program information to the image-associated information providing server 200 together with the broadcasting image information including the broadcasting image and sub-information.

The image-associated information providing server 200 may analyze the broadcasting image information received from the mobile device 100 and search one or more objects contained in the broadcasting image by using the broadcasting image information received from the mobile device 100. In an exemplary embodiment, an image-associated information providing server 200 is described by way of an example. Other devices may be used to provide image-associated information such as one of more devices of a content provider.

More particularly, the image-associated information providing server 200 may search pre-generated pattern information matched with the sub-information, and search a pattern corresponding to the broadcasting image by comparing with the searched pre-generated pattern information. The image-associated information providing server 200 may further search the one or more objects matched with the searched pattern.

The image-associated information providing server 200 may extract image-associated information matched with the searched one or more objects from pre-generated image-associated information in a database or through internet, and transmit the extracted image-associated information to the mobile device 100.

The mobile device 100 may provide the user with the image-associated information received from the image-associated information providing server 200. The image-associated information may include a video, an image, a text or URL information, etc. The mobile device 100 may provide the user with another contents, event information, etc., with reference to the image-associated information.

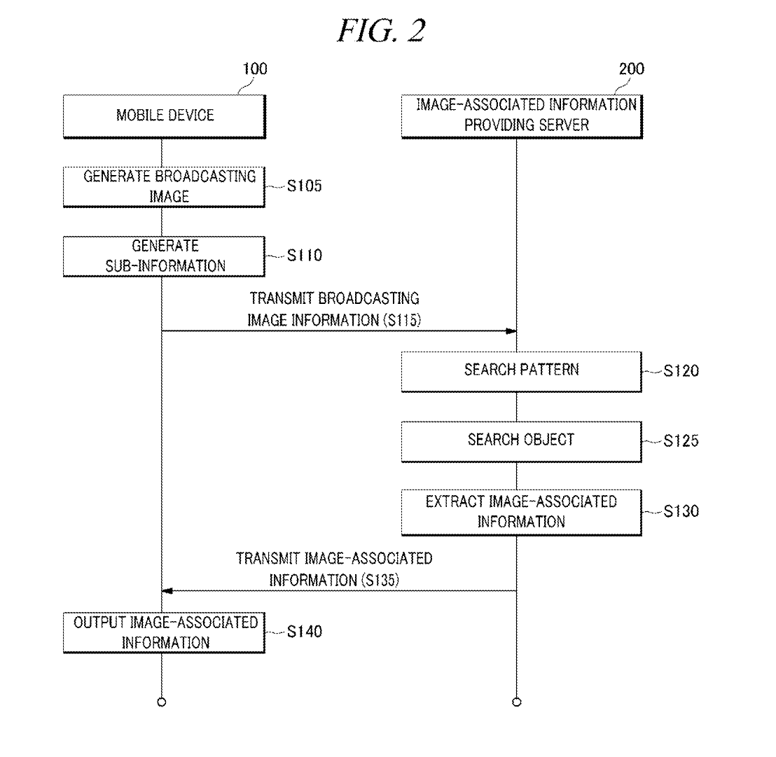

FIG. 2 is a flow diagram illustrating a method of providing image-associated information according to an exemplary embodiment.

In operation S105, the mobile device 100 generates a broadcasting image of an image output on a screen of a display device, e.g., a TV. That is, the mobile device 100 takes a picture of a scene of a broadcasting program output on the screen of the display device by using a camera included in the mobile device 100. In this way, the mobile device 100 may generate a broadcasting image of the broadcasting program provided on the screen of the display device.

When the mobile device 100 generates the broadcasting image, the mobile device 100 may also generate time information indicative of time when the broadcasting image is generated. The mobile device 100 may match the generated time information with the broadcasting image.

In operation S110, the mobile device 100 may generate sub-information by having the user select a broadcasting program from program information provided to the mobile device 100.

More particularly, the mobile device 100 may provide the user with program information of broadcasting programs broadcasted to the user on the screen of display device in a real time. Then, the mobile device 100 may receive from the user an input for selecting one broadcasting program among multiple broadcasting programs included in the program information.

In this way, the mobile device 100 may provide the user with the broadcasting schedule information or VOD list information, and generate the sub-information based on the user's input which includes selecting the broadcasting program.

In operation S115, the mobile device 100 transmits the broadcasting image information including the broadcasting image generated in operation S105 and the sub-information generated in operation 110 to the image-associated information providing server 200.

In operation S120, the image-associated information providing server 200 may search for a pattern by using the broadcasting image information received in operation S115.

That is, the image-associated information providing server 200 may search for patterns by analyzing the received broadcasting image and the received sub-information. By way of example, the image-associated information providing server 200 may analyze the received broadcasting image and search for a face pattern of a person, a shape pattern of an object, etc., included in the broadcasting image. In an exemplary embodiment, the image-associated information providing server 200 detects patterns that are present in the broadcasting image.

Further, the image-associated information providing server 200 may search for a pattern in the broadcasting image by using the sub-information received together with the broadcasting image. That is, the image-associated information providing server 200 may search pre-generated pattern information matched with the sub-information from a pattern database (not shown). The image-associated information providing server 200 may then retrieve the pre-generated pattern information that matched the provided sub-information and may temporarily store it in a memory associated with the server. Then, the image-associated information providing server 200 may compare the analyzed broadcasting image with the pre-generated pattern information retrieved from the pattern database to determine if the pre-generated pattern information is present in the broadcasting image. That is, in an exemplary embodiment, the image-associated information providing server 200 searches for presence of the retrieved pre-generated pattern information in the broadcasting image by comparing patterns in the broadcasting image to the retrieved pre-generated pattern information. In this way, the image-associated information providing server 200 can search for the pattern in the broadcasting image more easily.

Further, in an exemplary embodiment, the image-associated information providing server 200 may search for a pattern in the broadcasting image, and compare the found patterns with the pre-generated pattern information retrieved from the pattern database.

In operation S125, the image-associated information providing server 200 may search for an object that matches the pattern found as a result of a search in operation S120. That is, the image-associated information providing server 200 may compare the pattern found as a result of a search in operation S120 with pre-generated object information in an object database and retrieve objects that matched the pattern found as a result of a search in operation S120.

By way of example, if the image-associated information providing server 200 searches a pattern of a watch A in operation S120, the image-associated information providing server 200 may compare the searched pattern of the watch A with pre-generated object shapes, and then search for an object that would match the found pattern of the watch A.

In operation S130, the image-associated information providing server 200 may extract image-associated information that matches the object found as a result of the search in operation S125. The image-associated information is retrieved from an image-associated information database. By way of example, the image-associated information providing server 200 may extract image-associated information that matches the object of the watch A which was found as a result of a search in operation S125. This image-associated information may include price information, sales information such as sales locations, manufacturer information, relevant site information, advertisement image information, and so forth.

In operation S135, the image-associated information providing server 200 may transmit the image-associated information extracted in operation S130 to the mobile device 100. The image-associated information providing server 200 may transmit the image-associated information extracted in operation S130 to the mobile device 100 in the form of contents such as a video, an image or a text, etc. Further, the image-associated information providing server 200 may also transmit information indicating how to acquire the image-associated information, e.g., URL (Uniform Resource Locator) information, to the mobile device 100.

In operation S140, the mobile device 100 outputs the image-associated information received in operation S135. According to setup, the mobile device 100 may immediately output the received image-associated information using a screen of a mobile device 100, or may first output a notice of the receipt of the image-associated information by, e.g., a pop-up window or a sound and then output the received image-associated information in response to the user's request. This received image-associated information may be output on the display device 10 or on a screen of the mobile device 100 or on both depending on user preference and settings. For example, the mobile device 100 may provide the received image-associated information to the display device 10 using Bluetooth or a wireless local access network (WLAN) network. The received image-associated information maybe in a format suitable for IPTV to be displayed by the display device 10 in addition to the current broadcast or instead of the current broadcast depending on user settings.

The user may be given a variety of information associated with the broadcasting image generated in operation S105 by using the image-associated information output using the mobile device 100. Further, the user may participate in an event matched with the broadcasting image generated in operation S105, e.g., an event may be a popularity survey.

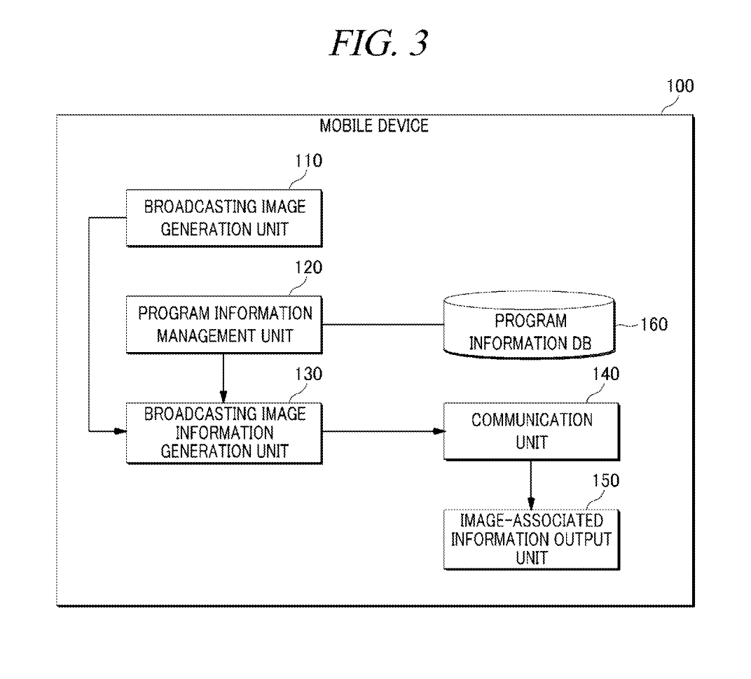

FIG. 3 is a block diagram illustrating a mobile device according to an exemplary.

The mobile device 100 according to an exemplary embodiment includes a broadcasting image generation unit 110, a program information management unit 120, a broadcasting image information generation unit 130, a communication unit 140, an image-associated information output unit 150 and a program information database (DB) 160. These exemplary units maybe software or a combination of software and hardware. For example, the program information database 160 may be an internal memory or a detachable memory of the mobile device 100. The mobile device 100 further includes a processor that may execute the broadcast image generation unit 110, the program information management unit 120, and the broadcast image information generation unit 130. The mobile device 100 may further include an antenna and other hardware components for communicating with an image-associated information providing server 200 via a network such a GSM network, CDMA network, Internet network, and so on and for communicating with the display device 10 using Bluetooth, WLAN, and so on. The mobile device 100 may further include a screen and a user interface for receiving user input which may include among the at least one of a touch screen, a keypad, a mouse, a voice input and recognition hardware and software components.

The broadcasting image generation unit 110 may capture an image output on a display device such as a TV and generate a broadcasting image. The broadcasting image generation unit 110 may capture the image by using an application installed in the mobile device 100 and generate the broadcasting image.

The program information management unit 120 may receive, from an external server (not illustrated), program information including broadcasting schedule information or VOD list information. Then, the program information management unit 120 stores the received program information in the program information database 160.

When the broadcasting image generation unit 110 generates the broadcasting image in response to the user's request, the program information management unit 120 provides the user with the program information stored in the program information database 160. Among the at least one broadcasting programs included in the received program information, the user may select a broadcasting program that he/she is currently watching. That is, the user may select a broadcasting program of which the broadcasting image is captured by the broadcasting image generation unit 110.

That is, the program information management unit 120 may generate sub-information based on the program information displayed on the mobile device and transmit the sub-information to the broadcasting image information generation unit 130.

The broadcasting image information generation unit 130 may generate broadcasting image information based on the broadcasting image generated by the broadcasting image generating unit 110 and the sub-information received from the program information management unit 120.

That is, the broadcasting image information generation unit 130 may generate broadcasting image information including the broadcasting image generated by the broadcasting image generation unit 110 and the sub-information received from the program information management unit 120.

The sub-information may further include time information indicative of the time when the broadcasting image is generated by the broadcasting image generation unit 110, allowing the user to readily search for the broadcasting program.

The communication unit 140 may transmit the broadcasting image information generated by the broadcasting image information generation unit 130 to the image-associated information providing server (not illustrated) and receive image-associated information corresponding to the transmitted broadcasting image information from the image-associated information providing server.

The image-associated information output unit 150 may output the image-associated information received, from the image-associated information providing server, by the communication unit 140. The image-associated information output unit 150 may immediately output the received image-associated information using a screen, or may first output a notice indicating the receipt of the image-associated information by, e.g., a pop-up window or a sound, and then output the received image-associated information in response to the user's request.

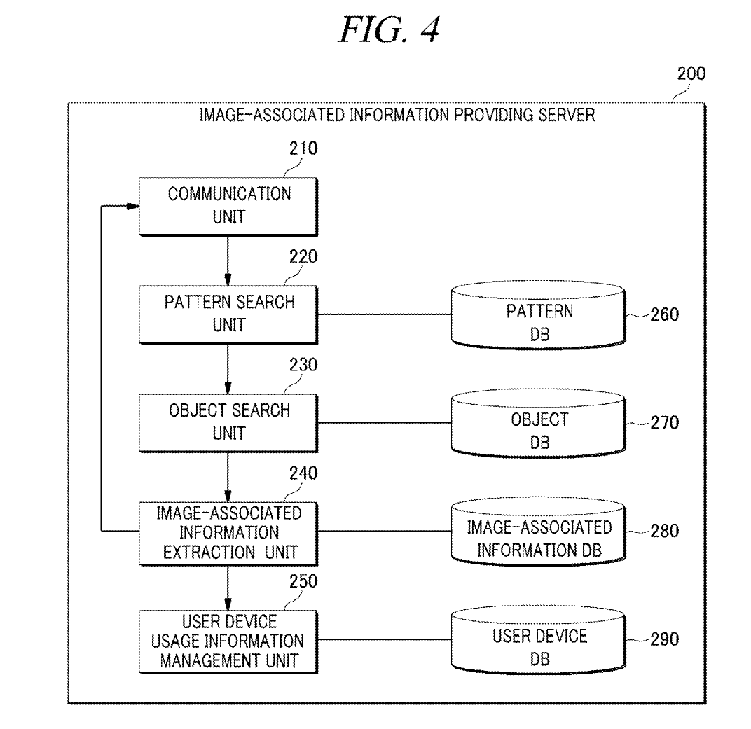

FIG. 4 is a block diagram illustrating an image-associated information providing server according to an exemplary embodiment.

The image-associated information providing server 200 according to an exemplary embodiment includes a communication unit 210, a pattern search unit 220, an object search unit 230, an image-associated information extraction unit 240, a user device usage information management unit 250, a pattern database (DB) 260, an object database (DB) 270, an image-associated information database (DB) 280 and a user device usage database (DB) 290. In an exemplary embodiment, the image-associated information providing server 200 includes a number of hardware components and the units may be software or a combination of software and hardware. For example, a memory may be provided which may include the pattern database 260, the object database 270, the image-associated information database 280 and the user device usage database 290. A processor may be provided which may execute the pattern search unit 220, the object search unit 230, the image-associated information extraction unit 240, and the user device usage information management unit 250. In addition, the image-associated information providing server 200 may further include an antenna and other hardware components for communicating with mobile devices such as the mobile device 100 via a network such a GSM network, CDMA network, Internet network, and so on.

The communication unit 210 may receive broadcasting image information from the mobile device (not illustrated) and provide the associated information to the mobile device. The broadcasting image information generated and transmitted by the mobile device may include not only a broadcasting image but also sub-information that is generated based on program information displayed on the mobile device, and that is including time information indicative of time when the broadcasting image is generated by the mobile device.

The pattern search unit 220 may search for a pattern corresponding to the broadcasting image information received, from the mobile device, by the communication unit 210. That is, the pattern search unit 220 may acquire the broadcasting image and the sub-information from the received broadcasting image information and search at least one pattern from the broadcasting image by comparing pre-generated pattern information that would match the sub-information. By way of example, the pattern search unit 220 may extract a pattern of a person or an object contained in the broadcasting image.

That is, by analyzing the sub-information included in the broadcasting image information, the pattern search unit 220 determines from which broadcasting program the broadcasting image is generated. Then, the pattern search unit 220 may search for a pattern from the pre-generated pattern information corresponding to the broadcasting program stored in the pattern database 260.

The pattern search unit 220 may analyze the broadcasting image and determine whether one or more searched patterns exist in the pre-generated pattern information stored for the target broadcasting program. Then, the pattern search unit 220 may search for the pattern that matches the broadcasting image. In this way, the pattern that matches the broadcasting image may be obtained more easily.

The object search unit 230 may search for an object from the object database 270 that matches the pattern found as a result of the search performed by the pattern searching unit 220. That is, the object search unit 230 searches the object database 270 for the object that matches the pattern from the broadcasting image information found as a result of the search performed by the pattern searching unit 220.

By way of example, the object search unit 230 may compare the pattern found as a result of the search by the pattern searching unit 220 with objects stored in the object database 270 and may retrieve a person object or a product object that matches the found pattern.

The image-associated information extraction unit 240 may extract information associated with the found object. That is, the image-associated information extraction unit 240 may search the image-associated information database 280, and extract image-associated information that matches the object found by the object search unit 230. Then, the image-associated information extraction unit 240 may transmit the acquired associated information to the mobile device (not shown) using the communication unit 210.

By way of example, if an object of a certain product is found by the object search unit 230, the image-associated information extraction unit 240 may extract image-associated information such as sales information, relevant site information, relevant image information, and the like.

The user device usage information management unit 250 may store, in the user device usage database 290, user device usage information such as usage history or search history for the information provided to the mobile device by the image-associated information extraction unit 240.

The user device usage information management unit 250 may choose information about an event, contents, advertisements, etc., suitable for the user by using the user device usage information stored in the user device usage database 290 and may provide the user with the chosen information using the communication unit 210.

Exemplary embodiments may be embodied in a transitory or non-transitory storage medium which includes instruction codes which are executable by a computer or processor, such as a program module which is executable by the computer or processor. A data structure according to exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of exemplary embodiments is provided for the purpose of illustration, and it will be understood by those skilled in the art that various changes and modifications may be made without changing a technical conception and/or any essential features of exemplary embodiments. Thus, above-described exemplary embodiments are illustrative in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of exemplary embodiments. It shall be understood that all modifications and embodiments conceived from the meaning and scope of the claims and their equivalents are included in the scope of the present inventive concept.

What is claimed is:

1. A method of providing image-associated information, the method comprising:
receiving broadcasting image information from a mobile device;
searching for an object that matches the received broadcasting image information;
extracting image-associated information that matches the object found in the searching; and
transmitting the extracted image-associated information to the mobile device.

2. The method of claim 1, wherein the broadcasting image information comprises a broadcasting image and sub-information related to the broadcasting image.

3. The method of claim 2, further comprising:
searching for pre-generated pattern information that matches the sub-information;
searching for a pattern corresponding to the broadcasting image from the pre-generated pattern information found in the searching; and
searching for an object that matches the pattern found in the searching.

4. The method of claim 2, wherein the sub-information is generated based on a user selection of program information provided by the mobile device.

5. The method of claim 4, wherein the program information comprises broadcasting schedule information or VOD list information.

6. The method of claim 2, wherein the sub-information comprises time information indicative of a time when the broadcasting image is generated by the mobile device.

7. The method of claim 1, wherein the image-associated information comprises at least one of contents and event information that are related to the broadcasting image information.

8. A method of obtaining image-associated information, the method comprising:
generating a broadcasting image;
transmitting, by a mobile device, broadcasting image information comprising the generated broadcasting image to a remote apparatus;
receiving by the mobile device image-associated information corresponding to the transmitted broadcasting image information from the remote apparatus.

9. The method of claim 8, wherein the broadcasting image information further comprises sub-information related to the generated broadcasting image.

10. The method of claim 9, wherein the sub-information is generated based on receiving a user selection of a broadcasting program from program information.

11. The method of claim 10, wherein the received image-associated information is related to the broadcasting image and the sub-information.

12. The method of claim 8, wherein the image-associated information comprises at least one of contents and event information that are related to the broadcasting image information.

13. An image-associated information providing apparatus comprising:
a pattern searching unit configured to search for a pattern in broadcasting image information received from a mobile device;
an object searching unit configured to search for an object that matches the pattern found by the pattern searching unit;
an image-associated information extracting unit configured to extract image-associated information that matches the searched object; and
a communication unit configured to provide the image-associated information to the mobile device.

14. The apparatus of claim 13, wherein the broadcasting image information comprises a broadcasting image and sub-information about the broadcasting image.

15. The apparatus of claim 14, wherein the sub-information is generated based on a user selection of program information provided by the mobile device.

16. The apparatus of claim 15, wherein the sub-information comprises time information indicative of a time when the broadcasting image is generated by the mobile device.

17. The method of claim 1, wherein the broadcasting image information comprises a broadcasting image that is captured by the mobile device from a broadcasting program being broadcast by a display apparatus.

18. The method of claim 17, wherein the broadcasting image is captured by a camera of the mobile device, wherein the broadcasting image information further comprises sub-information, and wherein a user of the mobile device identifies the broadcast program and the mobile device generates the sub-information based on the identified broadcast program.

19. The method of claim 2, further comprising:
identifying at least one pattern in the broadcast image;
identifying at least one pre-stored pattern based on the sub-information;
comparing the at least one identified pattern with the at least one identified pre-stored pattern; and
determining the object based on the comparison,
wherein the pattern comprises at least one of a shape pattern of an object included in the broadcasting image, and
wherein the extracted image-associated information is at least one of a video, an image, an audio, a text, and link information and comprises at least one of a sale price of the determined object, a sale location for the determined object, manufacturer information for the determined object, and advertisements related to the determined object.
